(19) United States
(12) Patent Application Publication
(10) Pub. No.: US 2024/0198935 A1
(43) Pub. Date: Jun. 20, 2024

(54) DEVICE AND METHOD FOR CONTROLLING POWER SUPPLY IN A VIDEO RECORDINGG DEVICE

(71) Applicants: HYUNDAI MOTOR COMPANY, Seoul (KR); KIA CORPORATION, Seoul (KR)

(72) Inventors: Ki Seon Ryu, Seoul (KR); Sung Kwan Choo, Hwaseong-si (KR); Sang Jin Lee, Hwaseong-si (KR); Ki Yong Lee, Ansan-si (KR); Ki Chul Kim, Suwon-si (KR)

(73) Assignees: HYUNDAI MOTOR COMPANY, Seoul (KR); KIA CORPORATION, Seoul (KR)

(21) Appl. No.: 18/519,874

(22) Filed: Nov. 27, 2023

(30) Foreign Application Priority Data
Dec. 16, 2022 (KR) 10-2022-0177170

(51) Int. Cl. B60R 16/033; B60L 1/00; B60L 3/12; B60L 58/12; B60R 1/22; B60R 16/023; H02J 7/00; H02J 7/34; H04N 23/65

(52) U.S. Cl. CPC B60R 16/033; B60L 1/00; B60L 3/12; B60L 58/12; B60R 1/22; B60R 16/0238; H02J 7/0049; H02J 7/0068; H02J 7/342; H04N 23/65; H02J 2310/48

(57) ABSTRACT

An apparatus includes a battery unit including a main battery for supplying driving power to a vehicle and a starting battery for supplying power to the video recording device, a smart battery sensor for transmitting state information of the battery to a power distribution device while monitoring a change in an SOC of the starting battery while the vehicle is parked, and requesting to charge the starting battery when the SOC is reduced to a predetermined SOC or less, the power distribution device for transmitting the state information of the battery to the video recording device and controlling whether to charge the starting battery when the vehicle is turned off, and the video recording device for calculating a recordable time capable of recording with the SOC of the starting battery, setting a recording timer, and recording surroundings of the vehicle using the power supplied from the starting battery while the vehicle is parked.

### CROSS-REFERENCE TO RELATED APPLICATION

The present application claims priority to Korean Patent Application No. 10-2022-0177170, filed on Dec. 16, 2022, the entire contents of which is incorporated herein for all purposes by this reference.

### BACKGROUND OF THE PRESENT DISCLOSURE

### Field of the Present Disclosure

The present disclosure relates to a device and a method for controlling power supply in a video recording device, and more specifically, to a device and a method for controlling power supply of a video recording device, configured for recording by use of only power of a starting battery while parking a vehicle.

### Description of Related Art

For the video recording device provided in the vehicle to capture a surrounding image, power supply from a battery provided in the vehicle is required. Accordingly, the battery is continuously charged while the vehicle is running, but when the vehicle is parked, the power is supplied only within the range of the remaining SOC value of the battery without charging.

Accordingly, in recent years, after a vehicle is provided with both a lead acid battery and a lithium battery, a change in the charging rate of the lead acid battery and the lithium battery is continuously checked, and power is supplied to a video recording device within a range that does not cause an obstacle to the driving of the vehicle.

However, to check the change in the charging rate of the two batteries, the communication state in the vehicle should be maintained, and thus, the communication state of the controllers in the vehicle may be maintained unnecessarily while the vehicle is parked. Therefore, there is a problem in that power consumption increases as the communication state is unnecessarily continuously maintained.

Furthermore, although the lithium battery has excellent charging efficiency and durability, but is expensive, an internal combustion engine vehicle generally includes the lithium battery as an auxiliary battery to minimize the total SOC value of the starting battery while the vehicle is parked.

Therefore, there is still a demand for a new device for controlling power supply of a video recording device capable of stably supplying power consumed in a video recording device during parking of the vehicle and for increasing recording time of the video recording device, while the vehicle includes a lead acid battery as a starting battery instead of an expensive lithium auxiliary battery.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a device and a method for controlling power supply of a video recording device, configured for stably securing recording time by minimizing dark current loss by recording in the video recording device with only power of a chargeable starting battery by a main battery while the vehicle is parked and also terminating a communication network in a vehicle during recording.

A device for controlling power supply of a video recording device for solving the above problem includes a main battery configured for supplying driving power of a vehicle, a battery unit including a starting battery which supplies power to a video recording device while the vehicle is parked, a battery sensor which transmits state information of the starting battery to a power distribution device while monitoring a change in the SOC value of the starting battery while the vehicle is parked, and requests charging when the SOC is reduced to a predetermined reference SOC value or less than the predetermined reference SOC value, a power distribution device which transmits the state information of the starting battery received from the battery sensor to a video recording device and is configured to control whether the starting battery is charged or not when the start-up of the vehicle is turned off, and a video recording device which calculates a recording available time with the SOC value of the starting battery received from the power distribution device and sets a recording timer, and films the surroundings of the vehicle by use of the power supplied from the starting battery while the vehicle is parked.

In the instant case, the battery sensor may detect the SOC value of the starting battery when the vehicle is turned off, and then may transmit the detected SOC value of the starting battery to the power distribution device.

Furthermore, the battery sensor may be configured to determine whether the SOC value of the starting battery corresponds to a predetermined charging start SOC as a value required for charging, and request charging of the starting battery to the power distribution device when the SOC value of the starting battery is equal to or less than the predetermined charging start SOC value.

The power distribution device may be configured for controlling the communication network of the vehicle to be terminated while the recording is performed in the video recording device.

Also, the power distribution device is configured to perform recording provided in the video recording device in response that the recordable time set by the recording timer provided in the video recording device has elapsed or in response that a signal for requesting the charging of the starting battery is received from the battery sensor, only a communication network with some upper level controllers required for the charging of the starting battery may be restrictively activated.

Furthermore, the power distribution device may be configured for controlling the starting battery to be charged up to a predetermined charging ending SOC value by use of power charged in the main battery.

Furthermore, the power distribution device generates a control signal for the charging of the starting battery by use of the power stored in the main battery, transmits a signal for requesting battery charging to a vehicle control unit provided in the vehicle. The vehicle control unit approving the battery charging converts a high voltage output from the main battery to a low voltage configured for being charged in the starting battery using a low-voltage DC-DC converter provided in the vehicle and then supplies the converted voltage, charging the starting battery.

The power distribution device may receive an SOC value of the starting battery after the charging is completed from the battery sensor, and then transmit the received SOC to the video recording device, and the video recording device may calculate the recordable time again based on a current SOC value of the starting battery, and then update the recordable time previously calculated, so that a time during which recording may be performed may be extended within a range of a target time.

Furthermore, after the starting battery is completely charged and the recordable time is updated, the power distribution device may terminate the communication network again that has been activated for the charging of the starting battery including the vehicle control unit and the low-voltage DC-DC converter.

According to another aspect of the present disclosure, there is provided a method for controlling a power supply of a video recording device, the method includes steps of calculating a recordable time of the video recording device while the vehicle is parked in a video recording device provided in a vehicle based on a charged amount of a starting battery when a vehicle is turned off, setting a recording timer using the recordable time in the video recording device and recording the surroundings of the vehicle using power of the starting battery, monitoring, by a battery sensor monitoring the starting battery, a change in the charged amount of the starting battery, and when it is determined that a current charged amount of the starting battery is reduced to a predetermined charging start SOC or less, requesting charging of the starting battery to a power distribution device provided in the vehicle, charging the starting battery using power stored in a main battery including a high voltage, in the power distribution device receiving a request for charging of the starting battery: and updating the recordable time, the updating of the recordable time including ending to charge when the charged amount of the starting battery reaches a predetermined charging ending SOC value, in the power distribution device, recalculating the recordable time in the video recording device based on the charged amount of the starting battery after charging, and setting the recording timer again based on a recalculated recordable time.

In the recording of the surroundings of the vehicle, the power distribution device may terminate the communication network of the vehicle to minimize the loss of the dark current while the recording is performed by the video recording device.

In the charging of the starting battery, when it is determined that a recordable time set by the recording timer has elapsed or when a signal for requesting the charging of the starting battery is received from the battery sensor, the power distribution device may restrictively activate only a communication network with some upper level controllers required for the charging of the starting battery.

Furthermore, in the step of charging the starting battery, the power distribution device may be configured to generate a control signal for the charging of the starting battery by use of the power stored in the main battery, transmit a signal for requesting charging of the battery to a vehicle control unit provided in the vehicle, and convert a high voltage output from the main battery into a low voltage which may be charged in the starting battery by a low-voltage DC-DC converter provided in the vehicle in the vehicle control unit that has approved the signal to supply the converted low voltage, charging the starting battery.

In the update of the recordable time, the video recording device may receive an SOC value of the starting battery after the charge is completed from the power distribution device, calculate the recordable time again based on a current SOC value of the starting battery, and update the recordable time previously calculated, so that a time during which the recording of the video recording device may proceed may be extended within a range of the target time.

In the updating of the recordable time, after the starting battery is completely charged and the recordable time is updated, a communication network that has been activated for the charging of the starting battery by including a vehicle control unit and a low-voltage DC-DC converter may be terminated again by the power distribution device.

According to the above-described various embodiments of the present disclosure, it is possible to minimize the dark current loss by terminating the communication network in the vehicle while the recording is performed by the video recording device in while the vehicle is parked.

Furthermore, the present disclosure can stably secure recording time by performing recording in the video recording device only with power of a starting battery while the vehicle is parked and charging the starting battery with high voltage of a main battery when SOC value of the starting battery is reduced to a certain level or less.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a block diagram showing a device configured for controlling power supply of a video recording device according to an exemplary embodiment of the present disclosure.

FIG. 2 is an exemplary view exemplarily illustrating an operating mechanism supplying power to a video recording device according to an exemplary embodiment of the present disclosure.

FIG. 3 is a graph illustrating a change in the SOC value of a starting battery during an operation of the video recording device according to an exemplary embodiment of the present disclosure.

FIG. 4 is a schematic diagram illustrating a method for controlling power supply of a video recording device according to an exemplary embodiment of the present disclosure.

FIG. 5 is a flow diagram illustrating an operational mechanism of monitoring a charge rate of a starting battery in a smart battery sensor and requesting a main battery to charge according to an exemplary embodiment of the present disclosure.

FIG. 6 is a flowchart illustrating an operation mechanism in which recording is performed in a video recording device while the vehicle is parked according to an exemplary embodiment of the present disclosure.

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, embodiments included in the present specification will be described in detail with reference to the accompanying drawings, in which the same or similar components are assigned the same reference numerals regardless of the reference numerals, and redundant descriptions thereof will be omitted. In the following description, suffixes “module” and “unit” for constituent elements are provided or used in combination only in consideration of ease of description, and do not have meanings or roles distinguished from each other by themselves. Furthermore, in describing the exemplary embodiments included in the present specification, when it is determined that the detailed description of the related known technology may obscure the gist of the exemplary embodiments included in the present specification, the detailed description thereof will be omitted. Furthermore, the accompanying drawings are merely for easily understanding the exemplary embodiments included in the present specification, and the technical spirit included in the present specification is not limited by the accompanying drawings, and it should be understood that all changes, equivalents, and substitutes included in the spirit and technical scope of the present disclosure are included.

Terms including ordinals such as first, second, etc. may be used to describe various elements, but the elements are not limited by the terms. The terms are used only for distinguishing one component from another component.

When it is mentioned that a component is “connected” or “linked” to another component, the component may be directly connected or connected to the other component, but it should be understood that another component may exist therebetween. On the other hand, when it is mentioned that a component is “directly connected” or “directly linked” to another component, it should be understood that another component does not exist therebetween. Furthermore, in the present specification, a singular expression is clearly defined in the context. Unless it means otherwise, it includes the expression of revenge.

In the present specification, it should be understood that the term “include” or “have” is directed to designate the presence of a feature, a number, a step, an operation, a component, a part, or a combination thereof described in the specification, but does not exclude the possibility of the presence or addition of one or more other features, numbers, steps, operations, components, parts, or combinations thereof in advance.

Furthermore, the unit or the control unit included in the name of the motor control unit (MCU), the hybrid control unit (HCU), or the like is a term widely used in the name of the controller configured for controlling a specific vehicle function, and does not mean a generic function unit. For example, each controller may include a communication device for communicating with another controller or a sensor to control a function in charge, a memory for storing an OS or a logic command, input/output information, and the like, and one or more processors for performing judgement, calculation, determination, and the like necessary for controlling a function in charge.

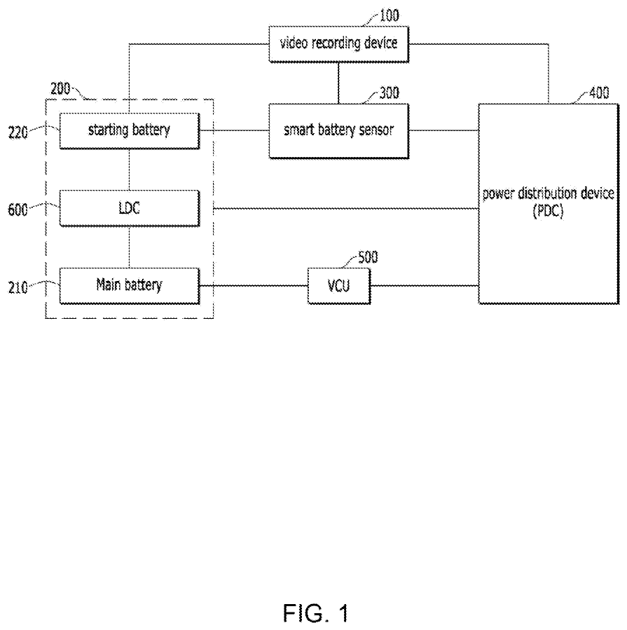

Hereinafter, an exemplary embodiment of the present disclosure will be described in detail with reference to FIG. 1 to FIG. 6.

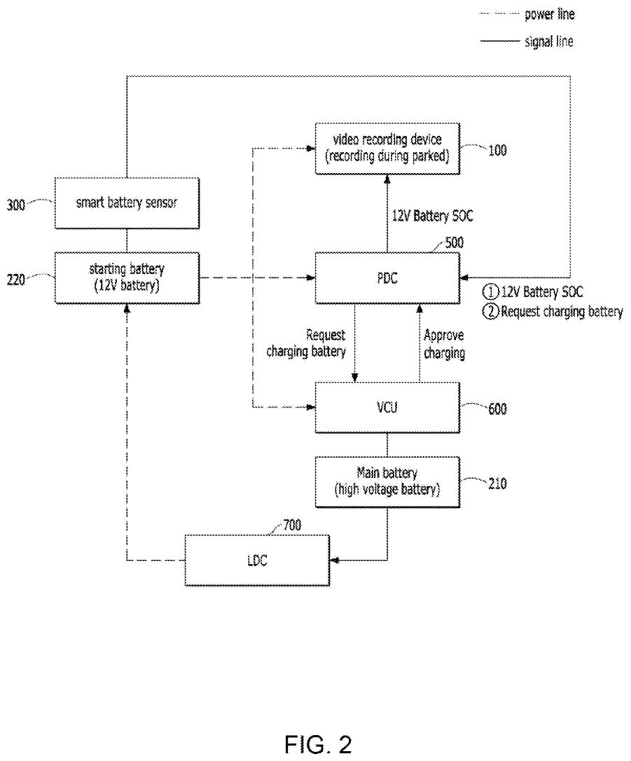

FIG. 1 is a block diagram illustrating a device configured for controlling power supply of a video recording device according to an exemplary embodiment of the present disclosure, and FIG. 2 is an exemplary diagram illustrating an operation mechanism for supplying power to a video recording device according to an exemplary embodiment of the present disclosure.

Referring to FIG. 1 and FIG. 2, a device configured for controlling power supply of a video recording device according to an exemplary embodiment of the present disclosure includes a video recording device 100 configured to capture and store images around the vehicle for a predetermined target time using only power supplied from a starting battery 220 while the vehicle is parked, a battery unit 200 including a high-voltage main battery 210 configured for supplying driving power of the vehicle and a low-voltage starting battery 220 configured for supplying power to the video recording device while the vehicle is parked, a smart battery sensor 300 configured to monitor a change in an SOC value of the starting battery 220 300 while the vehicle is parked, transmit state information, e.g., a state of charge (SOC) value of the starting battery 220 to a power distribution device (PDC) 400, and request charging when the SOC value of the battery 300 is reduced to a predetermined reference SOC value or less than the predetermined reference SOC value, and the power distribution device 400 configured to transmit the state information of the starting battery 220 received from the smart battery sensor 300 to the video recording device 100 and control whether to charge the starting battery 220 when the vehicle is turned off.

The video recording device 100 may be configured with a camera that captures an image of the surroundings of the vehicle and stores the captured image in a memory. At the instant time, the video recording device 100 is supplied with power only from the starting battery 220 in a state in which the vehicle is parked in a state in which the vehicle is turned off, and records images around the vehicle.

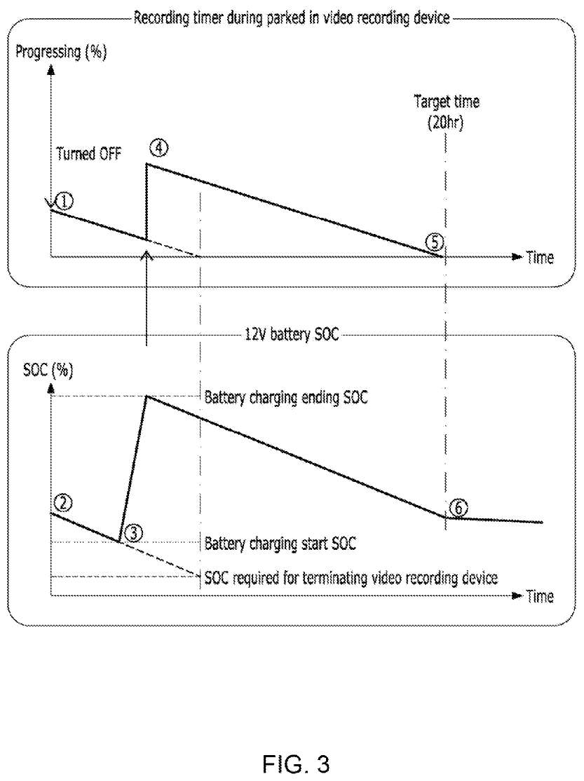

Also, the video recording device 100 is configured to perform recording for a predetermined target time while the vehicle is parked. Accordingly, as shown in FIG. 3, the video recording device 100 may set the target time to 20 hours, and in the instant case, the recording is maintained within the set target time unless the SOC value of the starting battery 220 is reduced to a predetermined value which is a level of SOC required for terminating the video recording device.

The video recording device 100 may calculate a recordable time for recording in the video recording device based on the SOC value of the starting battery 220 at the turned off time received from a power distribution device 400.

In the instant case, the video recording device 100 may calculate a recordable time by dividing a value obtained by subtracting the charging start SOC value from the current SOC value of the starting battery 220 by the amount of power consumption consumed in the video recording device 100. The calculated recording available time may be used as a value for setting a recording timer provided in the video recording device.

Furthermore, the main battery 210 is a high voltage battery configured for supplying power for driving an electric motor for generating driving force of the electric vehicle, and the power is supplied to various electronic parts provided in the vehicle. For example in a hybrid electric vehicle, the main battery may be charged while the vehicle is driven.

The electric vehicle may include not only a vehicle driven only by power of an electric motor, but also a hybrid vehicle configured for using power of both the electric motor and an internal combustion engine.

Furthermore, the starting battery 220 is a 12V battery which may be charged by receiving power from the high voltage main battery, and may supply power to the video recording device while parking.

In the instant case, the main battery 210 and the starting battery 220 may be configured as lead acid batteries. That is, in the case of an internal combustion engine vehicle or an electric vehicle according to the related art, a lithium auxiliary battery is often provided in consideration of charging efficiency and durability, but in an exemplary embodiment of the present disclosure, when the SOC value of the starting battery 220 reaches a predetermined charging start SOC value, charging from the main battery is performed by the power distribution device, and thus the starting battery 220 may be configured as a lead acid battery of low price even though the charging efficiency is somewhat low.

As described above, even when both the main battery 210 and the starting battery 220 are configured as lead acid batteries, the video recording device 100 does not maintain an unnecessary communication state between other controllers while receiving power only from the starting battery 220 and recording with the received power, minimizing the loss of dark current. Therefore, the recording time while the vehicle is parked may be increased, increasing marketability, compared to the conventional method of supplying power to the video recording device while continuously checking the SOC value of each of the lead acid battery and the lithium auxiliary battery.

Furthermore, the smart battery sensor 300 may monitor a change in the SOC value of the starting battery 220 while the vehicle is parked and transmit the monitoring result to the power distribution device 400. Based on the monitoring result, recording may be started in the video recording device 10, or whether charging using the main battery 210 is performed in the power distribution device may be controlled.

In the instant case, when the starting of the vehicle is turned off, the smart battery sensor 300 may detect the SOC value of the starting battery 220 at the moment when the starting of the vehicle is turned off, and then transmit the detected SOC value of the starting battery 220 to the power distribution device 400.

The video recording device 100 may calculate a recordable time for recording using the SOC value of the starting battery 220 at the time when the starting of the vehicle is turned off, transmitted as described above, set a recording timer provided in the video recording device using the calculated recordable time, and then start recording of the video recording device 100.

Furthermore, the smart battery sensor 300 may monitor the SOC value of the starting battery 220 which is changed while the power is consumed by the video recording device, and determine whether the current SOC of the starting battery 220 corresponds to a predetermined charging start SOC as a value required for charging.

When it is determined that the SOC value of the starting battery 220 is equal to or less than the predetermined charging start SOC value, the smart battery sensor 300 may request the power distribution device 400 to charge the starting battery 220.

In an exemplary embodiment of the present disclosure, the smart battery sensor 300 may include a processor to determine whether the SOC value of the starting battery 220 is equal to or less than the predetermined charging start SOC value.

In the instant case, the power distribution device 400 may be configured for controlling the communication network of the vehicle to be terminated while the recording is performed in the video recording device.

That is, the power distribution device 400 is configured to determine that the stable recording is to be performed for the estimated discharge time by the SOC stored in the starting battery 220, and terminates another communication network in the vehicle being parked, preventing power consumption due to dark current for maintaining an unnecessary communication network while the vehicle is parked.

Thereafter, when it is determined that the recordable time set by the recording timer has elapsed or when a signal for requesting charging of the starting battery 220 is received from the smart battery sensor, the power distribution device 400 restrictively activates only a communication network with some upper level controllers required for the charging of the starting battery 220, minimizing power consumption due to dark current while the vehicle is parked.

Furthermore, when the battery charging request is received from the smart battery sensor 300, the power distribution device 400 may be configured for controlling the starting battery 220 to be charged up to the charging ending SOC using the power charged in the main battery.

To the present end, the Power Distribution Unit (PDC) 400 may be configured to generate a control signal for charging the starting battery 220 by use of the power stored in the main battery 210.

In an exemplary embodiment of the present disclosure, the Power Distribution Unit (PDC) 400 may include a processor and a communication module. The communication module may include Controller Area Network (CAN) communication and/or Local Interconnect Network (LIN) communication. Furthermore, the communication module may include a wired communication module (e.g., a power line communication module) and/or a wireless communication module (e.g., a cellular communication module, a Wi-Fi communication module, and a short-range wireless communication module.

The PDC 400 transmits a signal for requesting charging of the starting battery 220 to a Vehicle Control Unit (VCU) 500 provided in the vehicle, and the vehicle control unit 500 that has approved the signal, is configured to discharge the power stored in the main battery 210 to the starting battery 220 to charge the starting battery 220.

At the present time, the vehicle control unit (VCU) 500 converts the high voltage output from the main battery into the low voltage of 12V which may be charged in the starting battery 220 by the low-voltage DC-DC converter (LDC) 600 provided in the vehicle and supplies the converted low voltage to the starting battery 220, charging the starting battery 220 up to the charging ending SOC value.

The smart battery sensor 300 may continuously monitor the SOC value of the starting battery 220 which is being charged by the main battery, and may be configured to determine whether the charging ending SOC is reached.

At the present time, because some vehicle networks are activated while the starting battery 220 is being charged, the power distribution device 400 may check a change in the SOC value of the starting battery 220 in real time through communication with the smart battery sensor 300, and may be configured to determine a final SOC value of the starting battery 220 at a time point when the charging is finished.

If the power distribution device 400 recognizes that the SOC value of the starting battery 220 reaches the charging ending SOC by the smart battery sensor 300, the charging may be then terminated by the power distribution device 400 transmitting a control signal for terminating the charging.

Furthermore, the power distribution device 400 may receive the SOC value of the starting battery 220 after recognizing completion of charging in the starting battery 220 by the smart battery sensor 300 and then transmit the received SOC value to the video recording device. The video recording device 100 may calculate the recordable time again based on a current SOC value of the starting battery 220, and then update the recordable time previously calculated, extending the time during which recording is performed within the range of the target time.

As described above, after the charging of the starting battery 220 is completed and the recordable time is updated, the power distribution device 400 may be configured for controlling to terminate another communication network including the vehicle control unit 500 and the low-voltage DC-DC converter 600 in the vehicle parked.

Accordingly, until the updated recordable time elapses or until the power distribution device 400 receives a signal requesting charging of the starting battery 220 from the smart battery sensor, the recording may be performed by the video recording device until the target time in a state in which another communication network in the vehicle is terminated.

As described above, the power distribution device 400 may perform recording in the video recording device even while the vehicle is parked by the power stored in the starting battery 220 while repeating the termination and partial activation of the communication network in the vehicle.

That is, the power distribution device 400 restrictively activates the vehicle network only in some cases, such as when the engine is turned off and when the battery is completely charged, minimizing power consumption which may be generated by maintaining an unnecessary vehicle network while recording in the video recording device.

Accordingly, unlike a power system of an internal combustion engine of the related art, in which recording time while the vehicle is parked increases or decreases according to the SOC when the main battery and the lithium auxiliary battery are turned off, the present disclosure can constantly maintain the recording time while the vehicle is parked by enabling the repeated charging of the starting battery 220 by the high voltage battery while using only the lead acid battery without a separate lithium auxiliary battery for additionally supplying power to the video recording device when the SOC value of the starting battery 220 decreases.

According to an exemplary embodiment of the present disclosure, each of the power distribution device 400 and the vehicle control unit 500 may be a processor (e.g., computer, microprocessor, CPU, ASIC, circuitry, logic circuits, etc.). Each of the power distribution device 400 and the vehicle control unit 500 may be implemented by a non-transitory memory storing, e.g., a program(s), software instructions reproducing algorithms, etc., which, when executed, controls operations of various components of the vehicle, and a processor configured to execute the program(s), software instructions reproducing algorithms, etc. Alternatively, the power distribution device 400 and the vehicle control unit 500 may be integrated in a single processor.

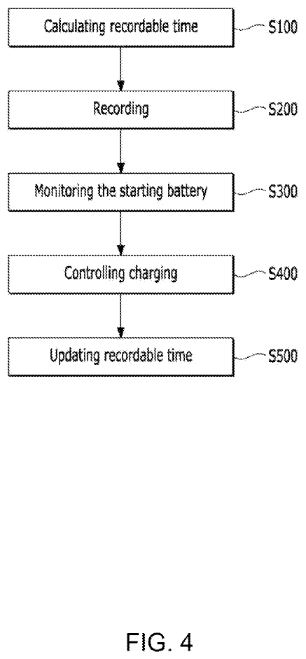

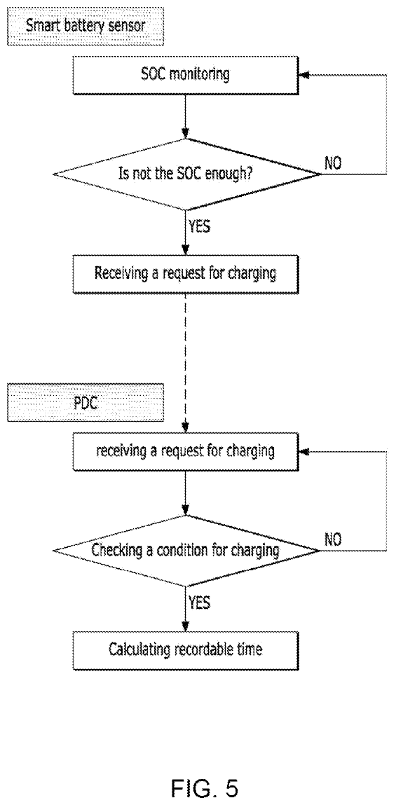

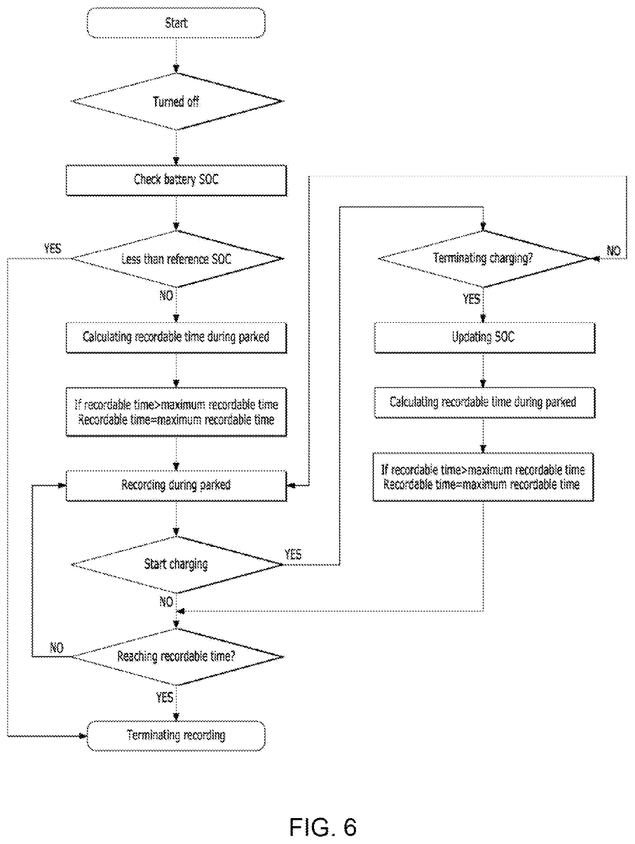

Next, a method for controlling power supply of a video recording device according to another exemplary embodiment will be described with reference to FIG. 4, FIG. 5 and FIG. 6.

FIG. 4 is a schematic diagram showing a method for controlling power supply of a video recording device according to an exemplary embodiment of the present disclosure, FIG. 5 is a flowchart showing an operation mechanism of monitoring a charge rate of a starting battery 220 in a smart battery sensor and requesting charging to a main battery according to an exemplary embodiment of the present disclosure, and FIG. 6 is a flowchart showing an operation mechanism of recording while the vehicle is parked in a video recording device according to an exemplary embodiment of the present disclosure.

Referring to FIG. 4, a method for controlling power supply of a video recording device according to another exemplary embodiment of the present disclosure includes, the video recording device provided in the vehicle turns off the starting of the vehicle. The method includes: a step (S100) of calculating a recordable time for recording while the vehicle is parked based on the SOC value of a starting battery 220 in the video recording device provided in the vehicle at a time point when the vehicle is turned off, a step (S200) of setting a recording timer using the recordable time in the video recording device and recording the surroundings of the vehicle using only power of the starting battery 220, a starting battery monitoring step (S300) of requesting charging of the starting battery 220 to a power distribution device provided in the vehicle when it is determined that the current SOC value of the starting battery 220 is reduced to less than or equal to a predetermined charging start SOC while monitoring a change in the SOC value of the starting battery 220 by a smart battery sensor which monitors the starting battery 220, a step (S400) of charging the starting battery 220 using power stored in a main battery of high voltage in the power distribution device which receives the request for charging of the starting battery 220, and a recordable time updating step (S500) of terminating charging of the starting battery 220 when the SOC value of the starting battery 220 reaches a predetermined charging ending SOC value and recalculating the recordable time in the video recording device, and setting the recording timer again with the recalculated time.

In the step of calculating the recordable time (S100), the smart battery sensor detects the charged amount of the starting battery 220 at a time when the vehicle is turned off, and then transmits the detected charged amount of the starting battery 220 to the power distribution device.

The video recording device utilizes the charged amount of the starting battery 220 after receiving the charged amount of the starting battery 220 from the power distribution device at the time when the vehicle is turned off. Thus, the recordable time for recording around the vehicle may be calculated.

In the instant case, the maximum recordable time for recording using the video recording device while the vehicle is parked refers to a time for which recording is desired to be performed as much as possible while the vehicle is parked, and thus the maximum recordable time may be mixed and expressed as a target time.

In the instant case, the video recording device may calculate the recordable time by dividing a value obtained by subtracting the charging start SOC from the current SOC value of the starting battery 220 by the power consumption amount consumed in the video recording device.

The power distribution device minimizes the loss of dark current by terminating the communication network in the vehicle while recording is performed by the video recording device while the vehicle is parked, maximizing the recordable time using the current charged amount of the starting battery 220.

In the step of recording the surroundings of the vehicle (S200), the video recording device sets a recording timer using the recordable time and performs recording, and the power distribution device terminates the communication network of the vehicle to minimize the loss of a dark current while the recording is performed in the video recording device.

Furthermore, in the step of recording the surroundings of the vehicle (S200), the driver may set the maximum recordable time, which is a maximum time desired to perform recording while the vehicle is parked, using the video recording device.

As shown in FIG. 6, if the recordable time is longer than the maximum recordable time, the recordable time is set to be shorter than the maximum recordable time.

In the starting battery monitoring step (S300), the smart battery sensor may monitor the SOC value of the starting battery 220 that changes while power is being consumed by the video recording device, and determine whether the current SOC is reduced to be equal to or less than the charging start SOC.

In the starting battery monitoring step (S300), when it is determined that the SOC value of the starting battery 220 is equal to or less than the charging start SOC value, the smart battery sensor may request the power distribution device to charge the starting battery 220.

In the step of charging the starting battery 220 (S400), when the battery charging request is received from the smart battery sensor, the power distribution device may be configured for controlling the starting battery 220 to be charged up to a predetermined charging ending SOC value by use of the power charged in the main battery.

Furthermore, in the charging of the starting battery 220 (S400), when it is determined that the recordable time set to the recording timer has elapsed or when a signal requesting charging of the starting battery 220 is received from the smart battery sensor, the power distribution device may restrictively activate only a communication network with some upper level controllers required for charging of the starting battery 220.

To the present end, the Power Distribution Unit (PDC) may be configured to generate a control signal for charging the starting battery 220 using the power stored in the main battery.

The PDC transmits a signal for requesting charging of a battery to a Vehicle Control Unit (VCU) provided in the vehicle, and the vehicle control unit that has approved the signal discharges power stored in the main battery to the starting battery 220 to charge the starting battery 220.

At the present time, the vehicle control unit (VCU) converts the high voltage output from the main battery into the low voltage of 12V which may be charged in the starting battery 220 by the low-voltage DC-DC converter (LDC) provided in the vehicle and supplies the converted low voltage, charging the starting battery 220 up to the charging ending SOC.

Furthermore, in the step of charging the starting battery 220 (S400), the smart battery sensor may perform an operation by determining whether the SOC value of the starting battery 220 which is being charged by the main battery reaches the charging ending SOC while continuously monitoring the SOC value of the starting battery 220.

In the recordable time update step (S500), the smart battery sensor continuously monitors the SOC value of the starting battery 220 being charged by the main battery, is configured to determine whether the amount of charging reaches the charging ending SOC value and transmits the determination result to the power distribution device.

When it is recognized by the smart battery sensor that the SOC value of the starting battery 220 reaches the charging ending SOC value, the power distribution device terminates to charge by transmitting a control signal for terminating charging.

In the recordable time update step (S500), the video recording device may receive the SOC value of the starting battery 220 from the power distribution device after the charging is completed, calculate the recordable time again based on a current SOC value of the starting battery 220, and update the recordable time previously calculated, so that the time in which recording may be performed may be extended within the range of the target time.

In the recordable time update step (S500), after the charging of the starting battery 220 is completed and the recordable time is updated, the power distribution device terminates another communication network including the vehicle control unit and the low-voltage DC-DC converter in the vehicle parked again.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured to process data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include
Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An apparatus for controlling power supply of a video recording device, the apparatus comprising:
a battery unit including a main battery configured for supplying driving power to a vehicle and a starting battery configured for supplying power to the video recording device while the vehicle is parked;
a battery sensor configured for transmitting state information of the battery to a power distribution device while monitoring a change in a state of charge (SOC) value of the starting battery while the vehicle is parked, and requesting to the power distribution device to charge the starting battery when the SOC is reduced to a predetermined SOC or less the predetermined SOC;
the power distribution device configured for transmitting the state information of the battery received from the battery sensor to the video recording device in response to the requesting of the battery sensor and controlling whether to charge the starting battery when the vehicle is turned off; and
the video recording device configured for calculating a recordable time for recording with the SOC value of the starting battery received from the power distribution device, setting a recording timer, and recording surroundings of the vehicle using the power supplied from the starting battery while the vehicle is parked.

2. The apparatus of claim 1, wherein the main battery and the starting battery are lead acid batteries.

3. The apparatus of claim 1, wherein the battery sensor detects the SOC value of the starting battery at a moment when the vehicle is turned off, and then transmits the detected SOC value of the starting battery to the power distribution device.

4. The apparatus of claim 1, wherein the battery sensor is configured to determine whether the SOC value of the starting battery corresponds to a charging start SOC value which is predetermined as a value required for the charging of the starting battery and is configured to request charging of the starting battery to the power distribution device in response that the SOC value of the starting battery is equal to or less than the predetermined charging start SOC value.

5. The apparatus of claim 1, wherein the power distribution device is configured to control a communication network of the vehicle to be terminated while the recording is performed in the video recording device.

6. The apparatus of claim 1, wherein the power distribution device is configured to restrictively activate only a communication network with predetermined upper level controllers required for the charging of the starting battery in response that the recordable time set by the recording timer provided in the video recording device has elapsed or in response that a signal for requesting the charging of the starting battery is received from the battery sensor.

7. The apparatus of claim 6, wherein the power distribution device is configured to control the starting battery to be charged up to a predetermined charging ending SOC value by use of power charged in the main battery.

8. The apparatus of claim 6, wherein the power distribution device is configured to generate a control signal for the charging of the starting battery by use of power stored in the main battery, to transmit a signal for requesting the charging of the starting battery to a vehicle control unit provided in the vehicle, and to convert a high voltage output from the main battery into a low voltage which is charged in the starting battery by a low-voltage DC-DC converter provided to the vehicle in the vehicle control unit that has approved the control signal, and to supply the low voltage to the starting battery for charging the starting battery.

9. The apparatus of claim 6,
wherein the power distribution device is configured to receive the SOC value of the starting battery after recognizing completion of the charging by the battery sensor and to transmit the received SOC to the video recording device, and
wherein the video recording device is configured to calculate the recordable time again based on a current SOC value of the starting battery, to update the recordable time previously calculated, and to extend the recordable time which the recording can be performed within a range of a target time.

10. The apparatus of claim 9, wherein the power distribution device is configured to terminate a communication network activated for the charging of the starting battery, the vehicle control unit and the low-voltage DC-DC converter again after the starting battery is completely charged and the recordable time is updated.

11. A method for controlling power supply of a video recording device, the method comprising:
calculating a recordable time of the video recording device while the vehicle is parked based on a state of charge (SOC) value of a starting battery at a time point when a vehicle is turned off, in the video recording device provided in a vehicle: setting a recording timer of the video recording device using the recordable time, and recording surroundings of the vehicle using power of the starting battery;
requesting for a power distribution device provided in the vehicle to charge the starting battery in response that a battery sensor monitoring the starting battery determines that a current SOC value of the starting battery is less than or equal to a predetermined charging start SOC while monitoring a change in the SOC value of the starting battery;
charging the starting battery using power stored in a main battery by the power distribution device receiving the requesting for the charging of the starting battery; and
updating the recordable time in response that the SOC value of the starting battery reaches a predetermined charging ending SOC value, wherein the power distribution device ends the charging, recalculates the recordable time in the video recording device based on the starting battery SOC after the charging, and then resets the recording timer.

12. The method of claim 11, wherein in the recording of the surroundings of the vehicle, the power distribution device is configured to terminate a communication network of the vehicle to minimize a loss of a dark current while performing the recording in the video recording device.

13. The method of claim 11, wherein in the charging of the starting battery, the power distribution device is configured to restrictively activate only a communication network with predetermined upper-level controllers required for the charging of the starting battery in response that the recordable time set by the recording timer has elapsed or in response that a signal for the requesting for the charging of the starting battery is received from the battery sensor.

14. The method of claim 13, wherein in the charging of the starting battery, the power distribution device is configured to generate a control signal for the charging of the starting battery by use of the power stored in the main battery, to transmit a signal for requesting to charge of the starting battery to a vehicle control unit provided in the vehicle, and to convert a high voltage output from the main battery into a low voltage which is charged in the starting battery by a low-voltage DC-DC converter provided to the vehicle in the vehicle control unit which approves the control signal, and to supply the converted low voltage for the charging of the starting battery.

15. The method of claim 14, wherein in the updating of the recordable time, the video recording device is configured to receive the SOC value of the starting battery from the power distribution device after the charging is completed, to recalculate the recordable time based on a current SOC value of the starting battery, and to update the recordable time calculated previously, so that a time in which the video recording device performs the recording is extended within a range of a target time.

16. The method of claim 14, wherein in the updating of the recordable time, the power distribution device is configured to terminate a communication network activated for the charging of the starting battery including a vehicle control unit and a low-voltage DC-DC converter again after the start battery is completely charged and the recordable time is updated.

17. A non-transitory computer-readable recording medium storing a program which performs, when executed by a processor, a method for controlling power supply of a video recording device, the method comprising:
calculating a recordable time of the video recording device while a vehicle is parked based on a state of charge (SOC) value of a starting battery at a moment when the vehicle is turned off, in the video recording device provided in the vehicle: setting a recording timer of the video recording device using the recordable time, and recording surroundings of the vehicle using power of the starting battery;
requesting for a power distribution device provided in the vehicle to charge the starting battery in response that a battery sensor monitoring the starting battery determines that a current SOC value of the starting battery is less than or equal to a predetermined charging start SOC while monitoring a change in the SOC value of the starting battery;
charging the starting battery using power stored in a main battery by the power distribution device receiving the requesting for the charging of the starting battery; and
updating the recordable time in response that the SOC value of the starting battery reaches a predetermined charging ending SOC value, wherein the power distribution device ends the charging, recalculates the recordable time in the video recording device based on the starting battery SOC after charging, and then resets the recording timer.

18. The non-transitory computer-readable recording medium of claim 17, wherein in the recording of the surroundings of the vehicle, the power distribution device is configured to terminate a communication network of the vehicle to minimize a loss of a dark current while performing the recording in the video recording device.

19. The non-transitory computer-readable recording medium of claim 17, wherein in the charging of the starting battery, the power distribution device is configured to restrictively activate only a communication network with predetermined upper-level controllers required for the charging of the starting battery in response that the recordable time set by the recording timer has elapsed or in response that a signal for the requesting for the charging of the starting battery is received from the battery sensor.

20. The non-transitory computer-readable recording medium of claim 17, wherein in the updating of the recordable time, the video recording device is configured to receive the SOC value of the starting battery from the power distribution device after the charging is completed, to recalculate the recordable time based on a current SOC value of the starting battery, and to update the recordable time calculated previously.
